(19) United States
(12) Patent Application Publication
(10) Pub. No.: US 2007/0268360 A1
(43) Pub. Date: Nov. 22, 2007

(54) REMOTE CONTROL PROGRAMMING SYSTEM AND METHOD

(75) Inventor: Erik Anders AHLGREN, Malmo (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/745,674

(22) Filed: May 8, 2007

Related U.S. Application Data
(60) Provisional application No. 60/747,731, filed on May 19, 2006.

(51) Int. Cl. H04N 7/14

(52) U.S. Cl. 348/14.01

(57) ABSTRACT

A method and device are provided for configuring a mobile device to control a controllable device. A wireless control signal is sent to the controllable device. Control command information is wirelessly received from the controllable device. The mobile device is configured to control the controllable device based on the received control command information.

### BACKGROUND

1. Technical Field of the Invention

Implementations described herein relate generally to configuring mobile devices and, more particularly, to using near field communication (NFC) to configure mobile devices as remote control devices.

2. Description of Related Art

The use of electronic apparatuses for media applications, such as TVs, video cassette recorders (VCRs), digital video/versatile disc (DVD) players, stereos etc., has e.g., caused people in their homes to have an increasing number of remote controls for controlling the electronic apparatuses. Typically an infrared (IR) interface is used for communicating data between the remote control and the electronic apparatus. A radio frequency (RF) interface may also be used for controlling an electronic apparatus from a remote control.

To reduce the number of remote controls, so called “universal remote controls” have been developed. These devices are capable of controlling a plurality of electronic apparatuses. A disadvantage of existing universal remote controls is that they are difficult to configure for use with specific electronic apparatuses. For example, a universal remote control may be configured for use with an electronic apparatus by entering a code, e.g., a multi-digit code, identifying the electronic apparatus on a keypad on the universal remote control. This requires that the user has knowledge of the code that identifies the electronic apparatus to be controlled. This may in turn require that the user has a precise knowledge of the brand and/or model name of the electronic apparatus to be controlled in order to find the correct code in, e.g., an electronically stored database or in a typed list of electronic apparatuses supported by the universal remote control. The process of manually finding the correct code may be time consuming and prone to errors, which may be a source of annoyance and frustration for the user.

Alternatively, the universal remote control may be configured by browsing through lists of brand and model names displayed on a display on the universal remote control and retrieving configuration data from a database located in the universal remote control. This way of configuring the universal remote control may also be time consuming and prone to errors, since the user needs to manually identify the electronic apparatus in the lists of brand and model names.

As another example, a universal remote control may be configured key by key in a learning mode of the universal remote control. This may be done, e.g. by directing an IR transmitter of a remote control configured to control the electronic apparatus towards a learning eye of the universal remote control and transmitting IR data corresponding to the key to be configured to the universal remote control. This process is repeated for each key that is to be configured. This way of configuring the universal remote control may also be time consuming and prone to errors.

The known techniques may be inefficient as they may be time consuming and/or may have relatively high error probabilities associated with them.

### SUMMARY

According to one aspect, a method for configuring a mobile device to remotely control a controllable device comprises sending a control signal to the controllable device; receiving control command information from the controllable device via a wireless connection; and configuring the mobile device to control the controllable device based on the received control command information.

Additionally, the wireless control signal is transmitted using a near field communication (NFC) protocol.

Additionally, the configuring may include configuring the mobile device to remotely control the controllable device.

Additionally, the control command information may include information for enabling remote control of the controllable device via an infrared communications protocol.

Additionally, the control command information may include information for enabling remote control of the controllable device via a radio frequency (RF) communications protocol.

Additionally, the received control command information may be stored in a memory associated with the mobile device.

According to another aspect, a mobile device includes first wireless logic configured to transmit a control signal to a controllable device and receive control command information from the controllable device. Processor logic is configured to configure the mobile device to remotely control the controllable device based on the received control command information.

Additionally, the first wireless logic may comprise NFC logic.

Additionally, the mobile device may include second wireless logic configured to transmit control signals to the controllable device based on the configuration of the mobile device.

According to yet another aspect, a method for configuring a mobile device to control a controllable device comprises transmitting a control signal to the controllable device; receiving an identification signal from the controllable device; identifying control command information associated with the identification signal; and configuring the mobile device to control the controllable device based on the identified control command information.

Additionally, the control command exchange signal may be transmitted using a NFC protocol.

Additionally, the identification signal may be transmitted by the controlled device using a NFC protocol.

Additionally, the identification signal may include identification information associated with the controllable device.

Additionally, the identification information may include at least one of a manufacturer name or a model number for the controllable device.

Additionally, the identifying may further comprise determining whether control command information associated with the received identification information is stored on the mobile device; and configuring the mobile device to control the controllable device based on the stored control command information.

Additionally, the method may further comprise transmitting a remote search request to a remote resource based on the received identification information when it is determined that the control command information is not stored on the mobile device; receiving control command information associated with the controllable device from the remote resource; and configuring the mobile device to control the controllable device based on the control command information received from the remote resource

Additionally, the transmitting a remote search request may comprise transmitting a remote search request to a remote server over a wireless network.

Additionally, the wireless network may comprise a cellular communications network.

Additionally, the wireless network may be comprise an IEEE 802.11 wireless network.

According to yet another aspect, a device comprises means for transmitting a control command exchange signal to a controllable device using a wireless protocol; means for receiving identification information from the controllable device in response to the control command exchange signal; means for determining whether control command information associated with the controllable device has been previously stored based on the received identification information; means for requesting the control command information from a remote resource when the control command information has not been previously stored; means for receiving the control command information from the remote resource; and means for configuring the device to remotely control the controllable device based on the received control command information.

Additionally, the device may comprise means for wirelessly controlling the controllable device based on the configuration.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a diagram of an exemplary system in which systems and methods consistent with principles of the invention may be implemented;

FIG. 2A is a diagram of an exemplary mobile device of FIG. 1;

FIG. 2B is a diagram of an exemplary controllable device of FIG. 1;

FIG. 3 is a flowchart of a first exemplary process for configuring a mobile device;

FIG. 4 is a flowchart of a second exemplary process for configuring a mobile device; and

FIG. 5 is an exemplary diagram of the processing described with respect to FIG. 4.

### DETAILED DESCRIPTION OF EMBODIMENTS

The following detailed description of the invention refers to the accompanying drawings. The same reference numbers in different drawings may identify the same or similar elements. Also, the following detailed description does not limit the invention.

A method is described for enabling configuration of a mobile device.

### Exemplary System

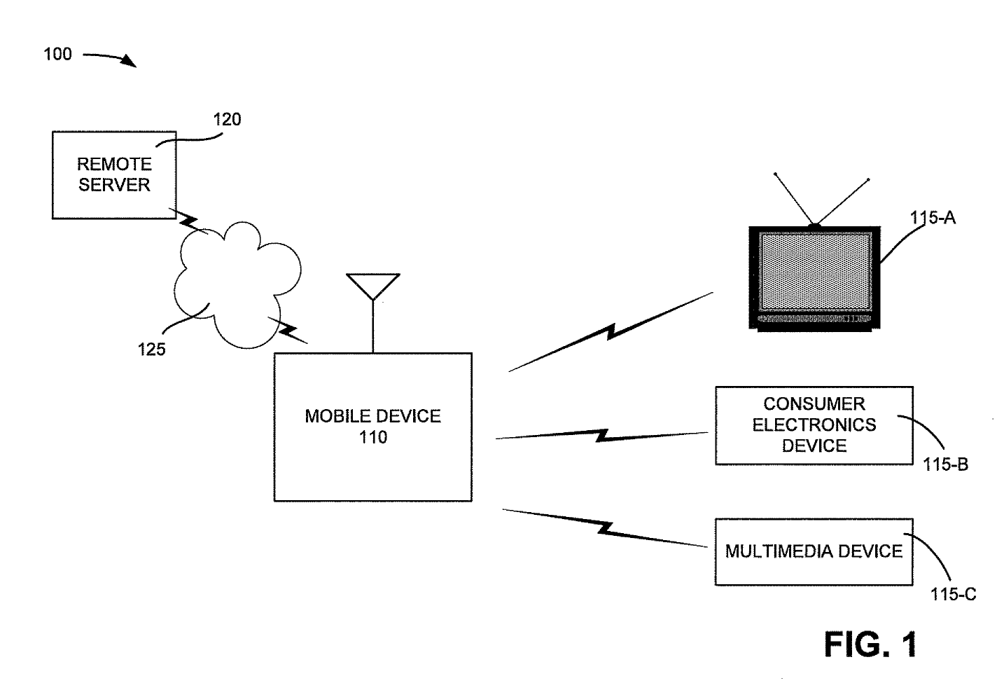

FIG. 1 is a diagram of an exemplary system 100 in which systems and methods consistent with principles of the invention may be implemented. As illustrated in FIG. 1, system 100 may include a mobile device 110, a number of controllable electronic devices 115-A to 115-C, referred to collectively as “controllable devices 115” or individually as controllable device 115, and a remote server 120. The number of mobile devices 110, controllable devices 115, and remote servers 120 illustrated in FIG. 1 is provided for simplicity. In practice, a typical system may include more mobile and controllable devices than illustrated in FIG. 1.

Mobile device 110 may include a cellular radiotelephone with or without a multi-line display; a Personal Communications System (PCS) device that may combine a cellular radiotelephone with data processing, facsimile and data communications capabilities; a Personal Digital Assistants (PDA) that can include a radiotelephone, pager, Internet/intranet access, Web browser, organizer, calendar and/or a global positioning system (GPS) receiver; a laptop and/or palmtop receiver or an appliance that includes a radiotelephone transceiver; and/or another similar type of device. Mobile device 110 may also be referred to as a “pervasive computing” device.

Controllable devices 115 may include any of a variety of electronic or entertainment devices, such as televisions, home media receivers, DVD and compact disc (CD) players, stereos, radios, personal computers, and the like. Control of these devices has heretofore generally been exercised by discrete infrared or RF remote controls or other hardware-based control mechanisms (e.g., buttons, dials, etc.). To facilitate such control, controllable devices 115 may include one or more receivers for receiving commands from the remote controls.

Remote server 120 may include any device remotely connected to mobile device 10 for providing information and services to mobile device 110 across a network 125. An exemplary remote server 120 may include a server connected to a cellular telephone provider and accessible via a cellular telephone wireless network. Alternately, remote server 120 may include a data server operatively connected to a wide area network (WAN), local area network (LAN), or the Internet, via wireless data networks, such as an 802.11 wireless network, a Bluetooth network, a WiMax network, etc. Network 125 may include a cellular network, the Internet, PSTN, or any network suitable for facilitating transfer of information between remote server 120 and mobile device 110.

In one implementation consistent with the principles of the invention, mobile device 110 and controllable devices 115 may communicate control command information wirelessly using a number of wireless communication protocols. For example, mobile device 110 may communicate with controllable devices 115 using the near field communication (NFC) protocol, which is a short-range wireless connectivity protocol that uses magnetic field induction to enable communication between devices when they are touched together or brought within, for example, a few centimeters of each other. Mobile device 110 may also communicate with controllable devices 115 using one or more other short distance wireless communication protocols, such as the Bluetooth protocol, the IEEE 802.11 protocol, etc. that may operate at longer distances. Mobile device 110 may be further configured to use an additional or other wireless communication protocol to communicate with a remote resource for providing or otherwise enabling exchange of the control command information. In some implementations, mobile device 110 may communicate via long range, such as a via long range infrared communications.

### Exemplary Mobile Device Configuration

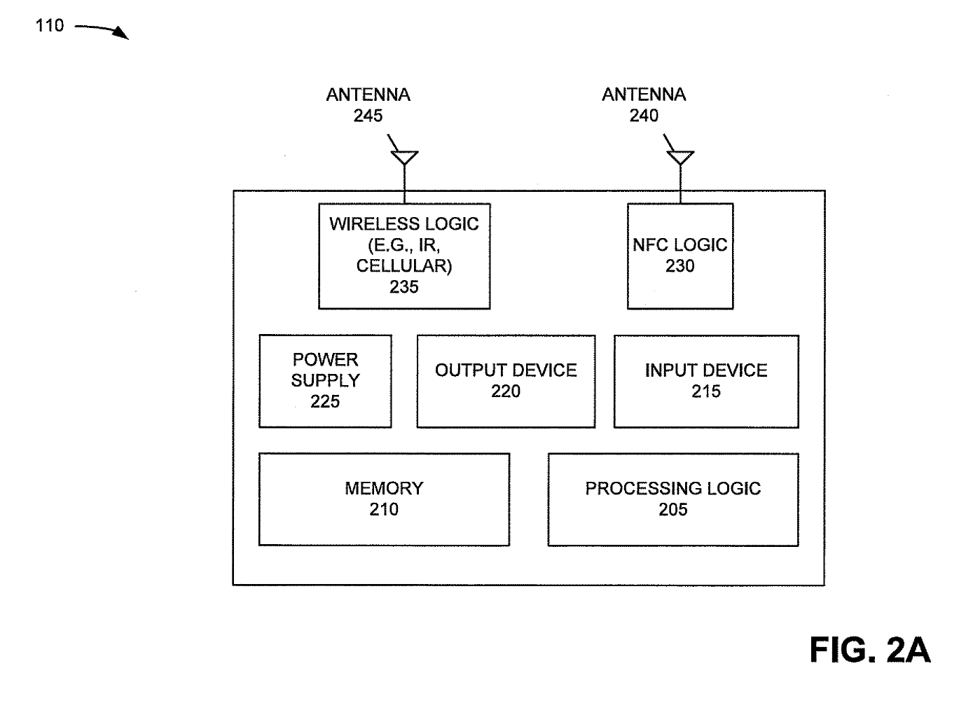

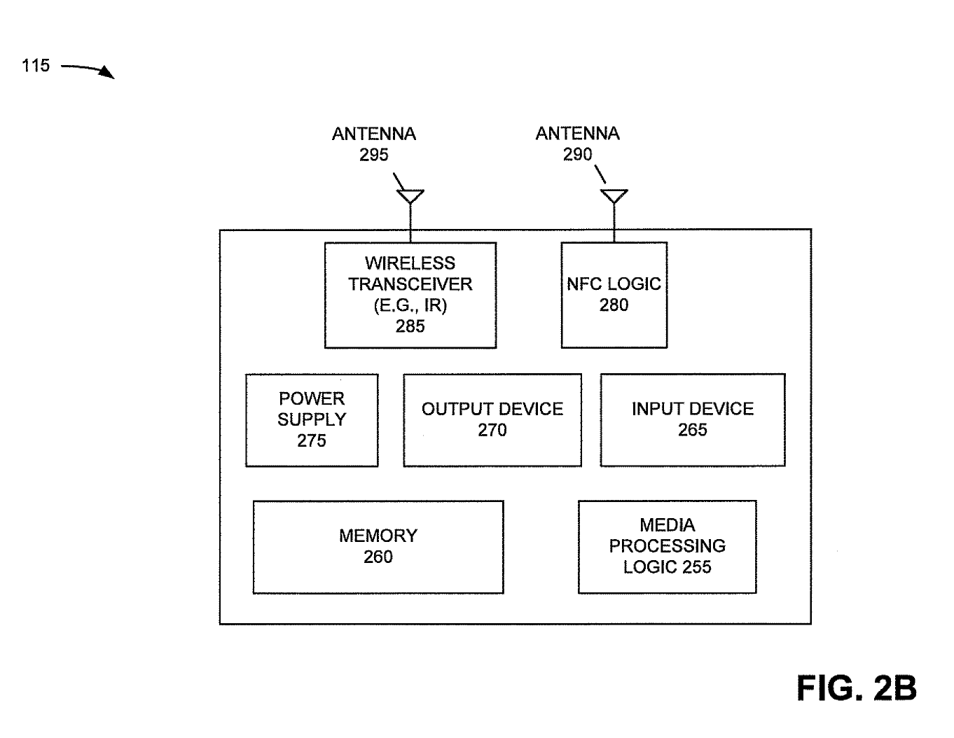

FIG. 2A is an exemplary diagram of mobile device 110. As illustrated, mobile device 110 may include processing logic 205, memory 210, input device 215, output device 220, a power supply 225, NFC logic 230, wireless logic 235, and antennas 240-245. It will be appreciated that mobile device 110 may include other components (not shown) that aid in receiving, transmitting, and/or processing data. Moreover, it will be appreciated that other configurations are possible.

Processing logic 205 may include any type of processor or microprocessor that may interpret and execute instructions. In other implementations, processing logic 205 may be implemented as or include an application specific integrated circuit (ASIC), a field programmable gate array (FPGA), or the like. Memory 210 may include a random access memory (RAM) or another type of dynamic storage device that may store information and instructions for execution by processing logic 205, a read only memory (ROM) or another type of static storage device that may store static information and instructions for processing logic 205, and/or some other type of magnetic or optical recording medium and its corresponding drive for storing information and/or instructions.

Input device 215 may include a device that permits a user to input information to mobile device 110, such as a keyboard, a keypad, a mouse, a pen, a microphone, one or more biometric mechanisms, and the like. Output device 220 may include a device that outputs information to the user, such as a display, a printer, a speaker, etc. Power supply 225 may include a battery, or the like, for providing power to the components of mobile device 110.

NEC logic 230 may include a transmitter device capable of transmitting data and control signals using the NFC protocol. For example, in one exemplary implementation, NEC logic 230 may transmit a control command exchange signal to a controllable device 115 that causes controllable device 115 to initiate exchange of control command information that subsequently enables mobile device 110 to remotely control controllable device 115 via wireless logic 235. In another implementation consistent with principles of the invention, NFC logic 230 may receive a control command exchange signal from controllable device 115 and may respond by pairing with the controllable device 115 to enable subsequent exchange of the control command information.

Wireless logic 235 may include a transceiver device capable of transmitting and receiving data and control signals using a wireless communications protocol, such as infrared, RF, Bluetooth, IEEE 802.11, and Ultra Wideband communications protocols. Wireless logic 235 may also include support for longer distance wireless communications protocols, such as a cellular radiotelephone protocol (e.g., GSM (global system for mobile communications), PCS (personal communication services), FDMA (frequency division multiple access), CDMA (code division multiple access), TDMA (time division multiple access), WiMax, etc.).

Antennas 240 and 245 may include, for example, one or more directional antennas and/or omni directional antennas for facilitating transmission and reception of wireless signals using any of the above-described wireless protocols.

As will be described in detail below, mobile device 110, consistent with the principles of the invention, may initially establish a short distance wireless connection with another device, such as one of controllable devices 115. In response to this connection, controllable device 115 may transmit or otherwise exchange command control information to mobile device 110. In alternate implementations, controllable device 115 may provide mobile device 110 with identification information associated with the controllable device 115. In response to receipt of this information, mobile device 110 may retrieve command control information associated with the identification information from a remote resource (via, e.g., wireless logic 235) or from memory 210. Mobile device 110 may perform these operations and other operations in response to processing logic 205 executing software instructions contained in a computer-readable medium, such as memory 210. A computer-readable medium may be defined as a physical or logical memory device and/or carrier wave.

The software instructions may be read into memory 210 from another computer-readable medium or from another device via, for example, NFC logic 230 and 235 or wireless logic 235. The software instructions contained in memory 210 may cause processing logic 205 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

FIG. 2B is an exemplary diagram of controllable device 115. As described above, controllable device 115 may include a home entertainment device, such as a DVD player, television or the like that is conventionally controlled by discrete remote control devices. In accordance with principles of the invention, it will be appreciated that controllable devices 115 may be configured, as appropriate, to respond to commands, requests, or even the presence of mobile device 110 to facilitate control configuration of mobile device 110. As illustrated, controllable device 115 may include media processing logic 255, memory 260, input device 265, output device 270, power supply 275, NFC logic 280, wireless transceiver 285, and antennas 290 and 295. As with mobile device 110, controllable device 115 may also include other components (not shown) that aid in receiving, transmitting, and/or processing data as well as additional components relating specifically to the device's media or entertainment capabilities, e.g., television tuners, optical media readers for DVD and CD players, etc. Moreover, it will be appreciated that other configurations are possible.

Media processing logic 255 may include any type of processor or microprocessor that may interpret and execute instructions. Media processing logic 255 may also be implemented as or include an application specific integrated circuit (ASIC), a field programmable gate array (FPGA), or the like. Memory 260 may include a RAM or another type of dynamic storage device that may store information and instructions for execution by media processing logic 255, a ROM or another type of static storage device that may store static information and instructions for the media processing logic 255, and/or some other type of magnetic or optical recording medium and its corresponding drive for storing information and/or instructions.

Input device 265 may include a device that permits a user to input information to controllable device 115, such as a control buttons, a keyboard or keypad, and the like. Output device 270 may include a device that outputs information to the user, such as a display (e.g. a television display), a speaker, audio or video outputs, etc. Power supply 275 may include a power inverter or converter for providing, adapting, or relaying power to the components of controllable device 115.

NFC logic 280 may perform similarly to NFC logic 230 described above, with respect to mobile device 110. For example, in one exemplary implementation, NFC logic 280 may initiate a control command exchange signal to NFC logic 230 of mobile device 110, where the control command exchange signal may include command control information for configuring mobile device 110 to control or to configure controllable device 115. In another implementation consistent with principles of the invention, NFC logic 280 may receive a control command exchange signal from mobile device 110 and may respond by pairing with mobile device 110 to enable subsequent exchange of the control command information. In an alternate implementation, NFC logic 280 may transmit control command information to mobile device 110 in response to receipt of a control command exchange signal.

Wireless transceiver 285 may include a receiver device capable of receiving data and control signals using a wireless communications protocol such as infrared, RF, Bluetooth, IEEE 802.11, and Ultra Wideband communications protocols. Wireless transceiver 285 may also include a transmitter device capable of transmitting data or control signals using a wireless protocol. Following command control configuration of mobile device 11, command signals for controlling controllable device 115 may be received by wireless receiver 285. Antennas 290 and 295 may include, for example, one or more directional antennas and/or omni directional antennas for facilitating transmission and reception of wireless signals using any of the above-described wireless protocols.

### Exemplary Processing

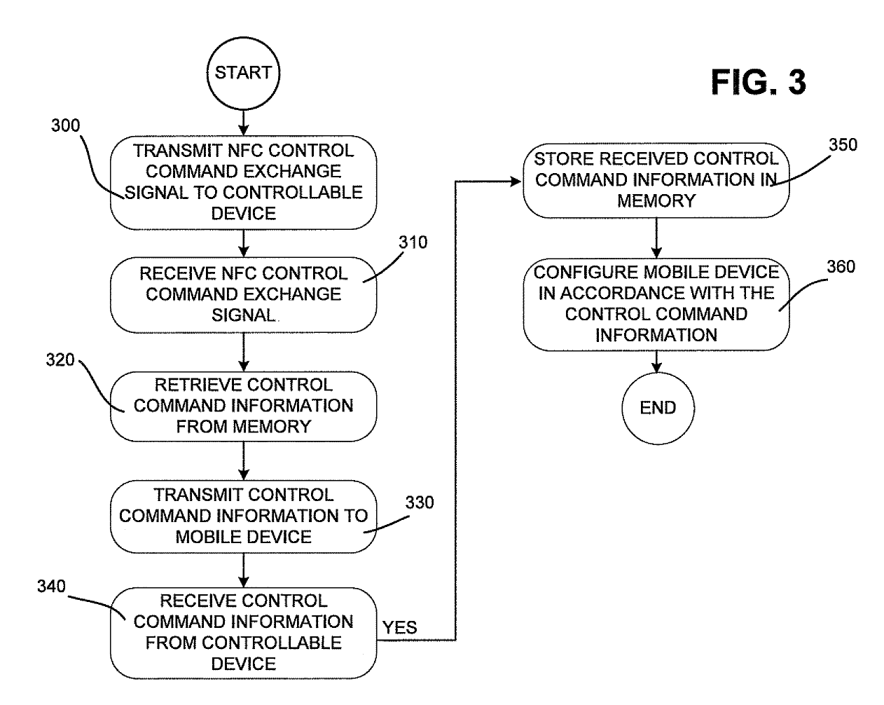

FIG. 3 is a flowchart of an exemplary process for enabling control command configuration via a wireless connection in an implementation consistent with the principles of the invention. It will be assumed for this process that a user of mobile device 110 wants to configure mobile device 110 to remotely control controllable device 115.

Processing may begin with mobile device 110 transmitting an NFC control command exchange signal to controllable device 115 (act 300). Mobile device 110 may transmit the control command exchange signal via NFC logic 230. The sending of the control command exchange signal may be triggered by some event. For example, in one implementation consistent with the principles of the invention, a user of mobile device 110 may cause mobile device 110 to transmit the control command exchange signal in response to a command from the user (e.g., the user pressing one or more buttons on mobile device 110). In an alternative implementation, mobile device 110 may transmit the control command exchange signal without the user's input (e.g., in response to a program running on mobile device 110).

For the purposes of this embodiment, it should be assumed that mobile device 110 is in close proximity to controllable device 115. Controllable device 115 may receive the control command exchange signal from mobile device 110 (act 310) via, for example, NFC logic 280. In response to the received control command exchange signal, NFC logic 280 may retrieve control command information from memory 260 (act 320) and may transmit the retrieved control command information to mobile device 110 (act 330). Controllable device 115 may retrieve the control command information location from memory 260 via a bus within controllable device 115. In another implementation consistent with principles of the invention, NFC logic 280 may transmit retrieve and transmit the control command information to mobile device 110 by way of one or more busses and through media processing logic 255, where it may be modified or supplemented with additional information prior to transmission to mobile device 110.

When received by mobile device 110 (act 340), mobile device 110 may store the received command control information in memory 210 (act 350). Mobile device 110 may then be configured in accordance with the stored control command information (act 360). In one implementation consistent with principles of the invention, control command information may include information for configuring a mobile device to remotely control or manipulate the controllable device. Examples of such information may include remote control codes or software instructions for enabling mobile device 110 control features, such as channel, volume, playback, etc. on controllable device 115.

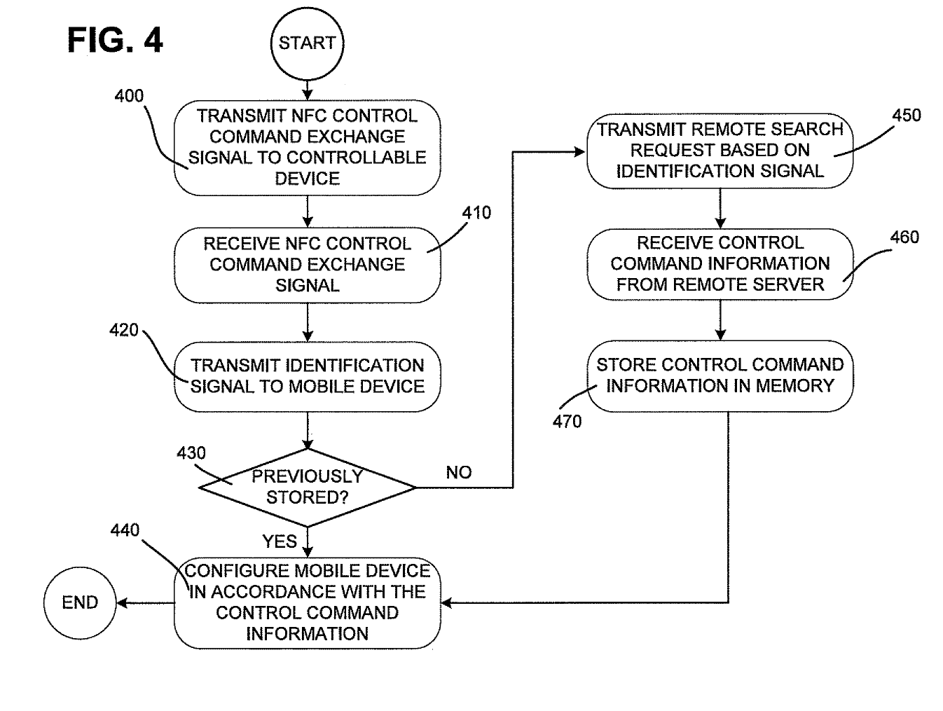

FIG. 4 is a flowchart of an exemplary process for enabling control command configuration via a short distance wireless connection in another implementation consistent with the principles of the invention. It will be assumed for this process that a user of mobile device 110 wants to configure mobile device 110 to remotely control controllable device 115.

Processing may begin with NFC logic 230 of mobile device 110 transmitting an NFC control command exchange signal to NEC logic 280 of controllable device 115 (act 400). NEC logic 280 receives the control command exchange signal (act 410) and, in response, transmits an identification signal to mobile device 110 via NFC logic 280 (act 420). The identification signal may include information uniquely identifying the controllable device 115, or a manufacturer and model of the controllable device 115, sufficient to enable control commands associated with the device to be identified. Upon receipt of the identification signal, mobile device 110 determines whether control command information associated with controllable device 115 has been previously stored in memory 210 (act 430). If control command information associated with controllable device 115 has been previously stored in memory 210, mobile device 110 may then be configured in accordance with the identified control command information (act 440).

If control command information associated with controllable device 115 has not been previously stored in memory 210, an external search for control command information may be transmitted to remote server 120 (or multiple remote servers 120) via wireless logic 235 (act 450). The external search may be based on the identification information received from controllable device 115. In one implementation consistent with principles of the invention, remote server 120 may include an external server computer accessed via wireless network 125 connected to a network such as a LAN, WAN, the Internet, etc. Alternatively, remote server 120 may connect to a personal computer (PC) via an IR and/or Bluetooth interface or to the Internet via general packet radio service (GPRS) or universal mobile telecommunications system (UMTS).

Control command information associated with the controllable device 115 may then be received from remote server 120 (act 460). In one implementation, the control command information is received by wireless logic 235 and stored in memory 210 (act 470). The process then proceeds to act 440 where mobile device 110 is configured in accordance with the received control command information.

### EXAMPLE

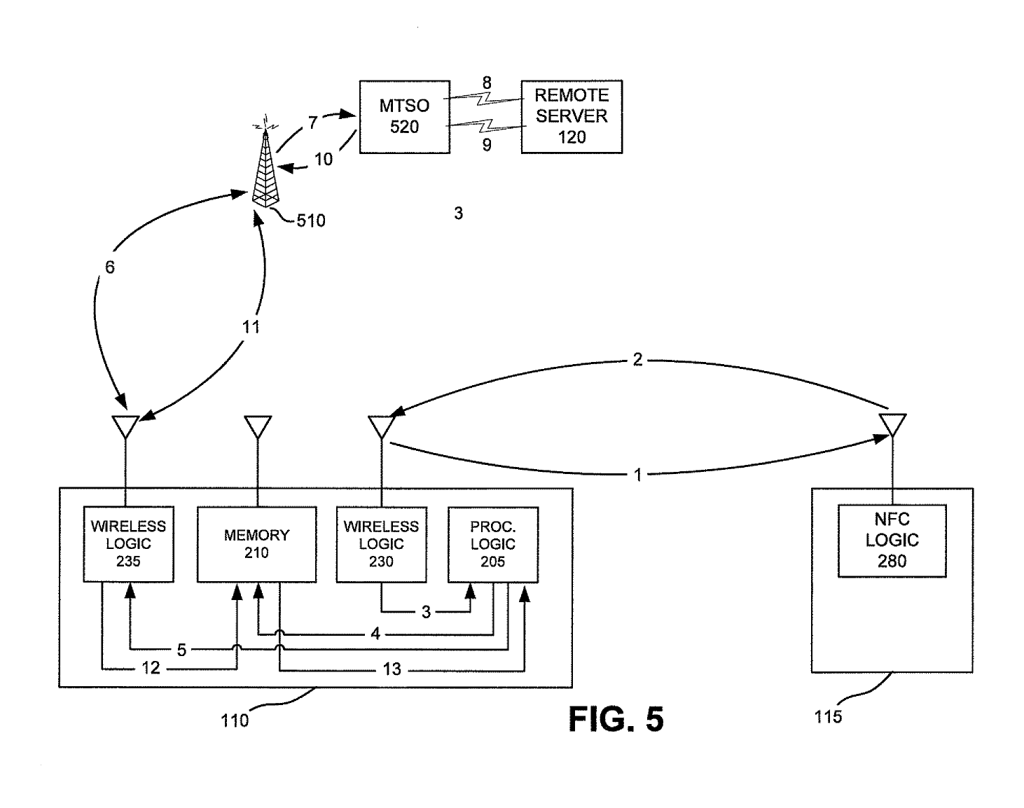

The following example illustrates the above processing. FIG. 5 is an exemplary diagram of one illustrative example of the processing described with respect to FIG. 4. For the present example, assume that a user of mobile device 110 wishes to configure mobile device 110 to control controllable device 115. The processing of FIG. 5 may begin with mobile device 110 transmitting a control command exchange signal (signal 1), via NFC logic 230, to controllable device 115.

Controllable device 115 may receive the control command exchange signal via NFC logic 280. NFC logic 280 may then, in response to the received control command exchange signal, transmit a controllable device identification signal to NFC logic 230 of mobile device 110 (signal 2). As described above, the identification signal may include information uniquely identifying the controllable device, or identifying a manufacturer and model of the controllable device, sufficient to enable control commands associated with the device to be identified and/or retrieved from another device.

In response to the received identification signal, NFC logic 230 transmits the received identification information to processing logic 205 (signal 3). Processing logic 205 queries memory 210 to determine whether control command information associated with the received identification information has been previously stored in memory 210 (signal 4). For the purposes of this example, it is assumed that such information is not previously stored in memory 210.

Once it has been determined that control command information associated with the received identification information has not been previously stored in memory 210, processing logic 205 transmits commands to wireless logic 235 initiating a remote request for the control command information (signal 5). Wireless logic 235 then relays the request to remote server 120 via a wireless signal transmitted to an antenna 510 (e.g., a cellular tower) (signal 6) and to a mobile telephone switching office (MTSO) 520 associated with the antenna 510 (signal 7). A exemplary network for transmitting signal 7 may include a data network, such as the Internet, an intranet or LAN, a wireless data network, a cellular network, an analog telephony network (e.g., the public switch telephone network (PSTN)), etc. MTSO 520 may then relay the identification information to remote server 120 by any suitable means, e.g., wireless, wired, or optical connections (signal 8).

Response signals from remote server 120 may be relayed to wireless logic 235 in a reverse path (signals 9-11). Once received by wireless logic 235, the control command information associated with controllable device 115 may be stored in memory 210 (signal 12) and forwarded to processing logic 205 for configuration of mobile device 110 (signal 13).

### CONCLUSION

Implementations consistent with the principles of the invention may provide a system for efficiently configuring mobile devices to remotely control other devices.

The foregoing description of preferred embodiments of the invention provides illustration and description, but is not intended to be exhaustive or to limit the invention to the precise form disclosed. Modifications and variations are possible in light of the above teachings or may be acquired from practice of the invention.

For example, while the description above focused on using the NFC protocol to transmit control command exchange signals and controllable device identification signals, it will be appreciated that other wireless communication protocols could alternatively be used to transmit the activation and deactivation signals.

While series of acts have been described with regard to FIGS. 3-5, the order of the acts may be modified in other implementations consistent with the principles of the invention. Further, non-dependent acts may be performed in parallel.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method for configuring a mobile device to remotely control a controllable device, comprising:
sending a control signal to the controllable device;
receiving control command information from the controllable device via a wireless connection; and
configuring the mobile device to control the controllable device based on the received control command information.

2. The method of claim 1, wherein the control signal is transmitted using a near field communication (NFC) protocol.

3. The method of claim 1, wherein the configuring includes:
configuring the mobile device to remotely control the controllable device.

4. The method of claim 3, wherein the control command information includes information for enabling remote control of the controllable device via an infrared communications protocol.

5. The method of claim 3, wherein the control command information includes information for enabling remote control of the controllable device via a radio frequency (RF) communications protocol.

6. The method of claim 1, further comprising:
storing the received control command information in a memory associated with the mobile device.

7. A mobile device comprising:
first wireless logic configured to:
transmit a control signal to a controllable device, and
receive control command information from the controllable device; and
processing logic configured to:
configure the mobile device to remotely control the controllable device based on the received control command information.

8. The mobile device of claim 7, wherein the first wireless logic comprises NFC logic.

9. The mobile device of claim 7, further comprising:
second wireless logic configured to:
transmit control signals to the controllable device based on the configuration of the mobile device.

10. A method for configuring a mobile device to control a controllable device, comprising:
transmitting a control signal to the controllable device;
receiving an identification signal from the controllable device;
identifying control command information associated with the identification signal; and
configuring the mobile device to control the controllable device based on the identified control command information.

11. The method of claim 10, wherein the control signal is transmitted using a NFC protocol.

12. The method of claim 10, wherein the identification signal is transmitted by the controlled device using a NFC protocol.

13. The method of claim 10, wherein the identification signal includes identification information associated with the controllable device.

14. The method of claim 13, wherein the identification information includes at least one of manufacturer name or a model number for the controllable device.

15. The method of claim 13, wherein the identifying further comprises:
determining whether control command information associated with the received identification information is stored on the mobile device; and
configuring the mobile device to control the controllable device based on the stored control command information when the control command information is stored on the mobile device.

16. The method of claim 15, further comprising:
transmitting a remote search request to a remote resource based on the received identification information when it is determined that the control command information is not stored on the mobile device;
receiving control command information associated with the controllable device from the remote resource; and
configuring the mobile device to control the controllable device based on the control command information received from the remote resource.

17. The method of claim 16, wherein the transmitting a remote search request comprises transmitting a remote search request to a server over a wireless network.

18. The method of claim 17, wherein the wireless network comprises a cellular communications network.

19. The method of claim 17, wherein the wireless network comprises an IEEE 802.11 wireless network.

20. A device comprising:
means for transmitting a control command exchange signal to a controllable device using a wireless protocol;
means for receiving identification information from the controllable device in response to the control command exchange signal;
means for determining whether control command information associated with the controllable device has been previously stored based on the received identification information;
means for requesting the control command information from a remote resource when the control command information has not been previously stored;
means for receiving the control command information from the remote resource; and
means for configuring the device to remotely control the controllable device based on the received control command information.

21. The device of claim 20, further comprising means for wirelessly controlling the controllable device based on the configuration.
